(19) United States
(12) Patent Application Publication
(10) Pub. No.: US 2018/0207846 A1
(43) Pub. Date: Jul. 26, 2018

(54) PRODUCTION AND POSITIONING METHOD FOR SEALING PROFILES

(71) Applicant: STEFAN PFAFF WERKZEUG- UND FORMENBAU GMBH & CO KG, Rothenbach im Allgau (DE)

(72) Inventor: Anton SUTTER, Weiler-Simmerberg (DE)

(73) Assignee: STEFAN PFAFF WERKZEUG- UND FORMENBAU GMBH & CO KG, Rothenbach im Allgau (DE)

(21) Appl. No.: 15/910,376

(22) Filed: Mar. 2, 2018

Related U.S. Application Data
(63) Continuation of application No. PCT/EP2016/071326, filed on Sep. 9, 2016.

(30) Foreign Application Priority Data
Sep. 10, 2015 (EP) 15184736.5

(51) Int. Cl. B29C 45/14; B29C 45/00

(52) U.S. Cl. CPC B29C 45/14065; B60J 10/16; B29C 45/0001; B29C 45/14409

(57) ABSTRACT

In order to improve manufacturing tolerances, a method for producing a positionable sealing profile for vehicle doors and a positioning method using sealing profiles with a positioning pin are proposed. In the production method in which a positioning pin is also injection-molded, at least two injection-molding processes are carried out before the tool is re-opened and/or without the sealing profile being alternatively reclamped in another tool. In the corresponding positioning method, the positioning pin may be moved against the stop and/or introduced into a recess, such that the positioning pin and thereby the sealing profile retain a defined position in relation to the tool.

### CROSS REFERENCE TO RELATED APPLICATIONS

This application is a continuation of International Application No. PCT/EP2016/071326 filed Sep. 9, 2016, which designated the United States, and claims the benefit under 35 USC § 119(a)-(d) of European Application No. 15184736.5 filed Sep. 10, 2015, the entireties of which are incorporated herein by reference.

### FIELD OF THE INVENTION

The present invention relates to a method for producing a positionable sealing profile for vehicle doors, as well as a positioning method for corresponding sealing profiles.

### BACKGROUND OF THE INVENTION

From the prior art it is known to manufacture sealing profiles, for example for vehicle doors, by individual profile parts being injection-molded onto a first profile, a so-called central profile, or first profile. In order to carry out such an injection-molding process, the central profile is pushed into a mold and/or the mold is pushed onto the profile, whilst the profile to be injection-molded thereon is also received in the mold and thus positioned such that it may be injection-molded at the desired location of the first profile. In order to undertake a further injection-molding process, the profile is removed therefrom and subsequently a further mold is pushed on in order to connect a different profile to the first profile. Separate injection-molding processes, by which a profile is not attached thereto but the end of a profile is merely provided with a plastics end, for example, may also be carried out.

### SUMMARY OF THE INVENTION

It is the object of the present invention to be able to maintain lower tolerances during the production and further processing of such sealing profiles.

The production method according to the present invention serves for producing a positionable sealing profile for vehicle doors. Such sealing profiles are inserted on the bodywork along the door edges and ensure, amongst other things, that no moisture penetrates the vehicle interior and/or that the vehicle interior is sealed relative to the outside. During the production process, generally an extruded profile is used, this profile also being denoted as a central profile or first profile. Generally, it is more advantageous not to produce the entire profile from an extruded profile but to attach one or more profile parts thereto. This attachment is undertaken by an injection-molding process, i.e. the first profile and the profile part to be injection-molded thereon are moved into a mold and the intermediate region is correspondingly filled by the plastics and/or rubber material used in the injection-molding process, such that both parts are in contact with one another. Even in the end regions it is often not sufficient for the extruded profile to be simply cut to length at this point, but the end has to have a specific shape. Also in this case an injection-molding is carried out with the corresponding plastics material and/or rubber.

In the production method according to the present invention, accordingly the first profile is introduced into a tool and retained and/or clamped. Depending on the type of method, the profile may be introduced into the mold; but often the profile is pushed into the mold or the mold is pushed onto the profile. The tool is generally a mold for receiving sealing profiles in a retained manner and for the further processing thereof and/or a corresponding receiving device therefor. Moreover, the profile is often not fully received in a mold but generally only a specific region, for example, the end region of the profile in which the injection-molding process is intended to take place for attaching a further profile part thereto or for carrying out a final injection-molding. The tool is subsequently introduced into an injection-molding machine which undertakes the actual injection-molding process.

Optionally a further processing step may also be carried out on the clamped profile, for example, cutting the profile to length.

The production method according to the present invention is characterized, in particular, in that after introducing the first profile into the tool, at least two injection-molding processes are subsequently carried out before the tool is opened again and/or alternatively without having to reclamp the sealing profile in a different tool. In principle, therefore, these two injection-molding processes may both be carried out in one and the same tool, in parallel and/or simultaneously. It is also conceivable that whilst the processes take place one after the other chronologically, namely for production technology reasons, the profile does not have to be reclamped in a different tool and/or removed from the tool and introduced into a different tool. In particular, when the effort required for the at least two injection-molding processes, which are carried out in the same tool, is different or different plastics materials and/or rubber are injection-molded, the processes may optionally overlap chronologically but potentially they do not start at the same time and/or are not completed at the same time.

Moreover, the present invention is also based on the fact that in one of the at least two injection-molding processes, a further profile part is injection-molded on the first profile part, and in a further injection-molding process of the at least two injection-molding processes a positioning pin is injection-molded to the side onto the first profile and/or the further profile part. The positioning pin is configured to be used as a stop for positioning on the vehicle and/or in a tool. Such a positioning pin is an injection-molded part which, for example, is attached onto the profile at the side as a plastics tab. This positioning pin may be used as a positioning reference and namely in several aspects: initially it may serve as a positioning reference on the vehicle and/or on the vehicle body. For example, a stop or a recess may be provided therefor on the vehicle body, the positioning pin being moved thereagainst and/or the positioning pin being introduced therein. Since the positioning pin serves as a reference, therefore, the sealing profile to be installed on the vehicle has a precise defined position.

However, the positioning method according to the invention also permits the positioning pin to be used for positioning in a further tool. It is conceivable, for example, that in the further production method the sealing profile is designed to be reclamped in a further tool, namely when further profile parts are injection-molded in the region of a pillar (for example, the B-pillar or C-pillar of the vehicle), and these profile parts are moved relatively far away from the injection-molding carried out previously, the profile having been already clamped therefor. However, in this case it is also possible to use the positioning pin as a positioning reference in the further tool so that the further injection-molding or the further processing step may be carried out in a positionally accurate manner relative to the positioning pin.

The production method according to the present invention, therefore, firstly permits the injection-molding process, which is carried out in the same tool and which takes place together with the injection-molding of the positioning pin, to be able to be implemented very accurately in terms of position.

Secondly, however, by the production method according to the present invention time may also be saved during manufacture, since between the two processing and/or injection-molding processes the profile does not have to be reclamped in a further tool.

In one embodiment of the present invention, the positioning pin is injection-molded from a different material, in particular from a different plastics material, from the profile part. Preferably, polypropylene may be used for the positioning pin. In particular, it may be advantageous to injection-mold the positioning pin from a harder material than the material which is otherwise used for the remaining sealing profile. Thus the handling of the positioning pin, when it functions as a stop or as a part to be inserted into a recess and/or opening, may be improved and/or simplified thereby. During the injection-molding of different materials, it should be taken into account that different processing times may regularly occur and also the injection-molding may take place at different temperatures.

Particularly advantageously, the production method may be carried out on one of the ends of the first profile, so that here a sealing profile corner is produced. In the corners, for accurate positioning it is often not sufficient to insert the profile during manufacture into the mold until the end bears against the inner wall of the mold, since firstly cutting tolerances have to be considered and secondly, in the case of end injection-moldings, the production thereof could also further increase the tolerances.

Accordingly, the method according to the present invention for positioning a sealing profile for vehicle doors takes place in a tool by using a sealing profile with a positioning pin attached thereto, wherein such a tool is used which comprises a stop and/or a recess/opening and the positioning pin is moved against the stop and/or introduced into the recess/opening, such that the positioning pin and thereby the sealing profile retain a defined position in relation to the tool. By this positioning method according to the present invention, in the same manner as in the production method according to the present invention, a reduction of production tolerances is possible, i.e. the sealing profiles may be produced much more accurately and it is still possible to guarantee that the seals may be easily inserted into corresponding vehicles even in the case of mass production.

Similarly, for the production method according to the present invention, advantageously the positioning pin, which is actually provided for accurate positioning in the bodywork, is also used here to undertake an accurate positioning in the tool. In the production method according to the present invention the second injection-molding, namely an end injection-molding or the injection-molding of a further profile, had an accurate position relative to the positioning pin, since both are produced in the same tool. In the positioning method according to the present invention, the same advantage is utilized even when the profile has to be reclamped, by the positioning pin in the tool serving as a positioning reference which results in increased accuracy.

Moreover, a time advantage may be achieved even when reclamping the profile onto a different tool, since (in particular with automated reclamping) this reclamping process may be adjusted to the positioning pin which is used as a reference. To this end, for example, the positioning pin may be optically detected or the stop may be detected by pressure sensors, etc. This simplifies the automated process and may accelerate the production, since it is able to be detected by a sensor when the sealing profile has the correct position in the tool.

The positioning pin, however, does not necessarily have to be injection-molded onto the central and/or first profile. It is also conceivable that the positioning pin is injection-molded onto a profile part and is then used as a reference. In particular, when the first profile is introduced into a tool and subsequently the additional profile part is introduced into the tool, for improving the accuracy it is important that both the first profile and the profile part have adopted correct positioning before the start of the injection-molding process. For the correct positioning, therefore, a positioning pin may not only be used on the first profile but also on the additional profile part which is injection-molded thereon.

As already set forth above, in an exemplary embodiment of the positioning method, in particular, a positioning pin which is injection-molded from a different material from the remaining sealing material, such as, for example, polypropylene, may be used. In particular, the properties as a stop or the detection of the stop of the positioning pin may be simplified and/or improved thereby, since the positioning when using a harder material as the stop or joining tab improved handling but also more accurate positioning may result than with a soft, flexible material.

### BRIEF DESCRIPTION OF THE DRAWINGS

Exemplary embodiments of the present invention are shown in the drawings and are described in more detail hereinafter with the disclosure of further details and advantages.

FIG. 1 shows an arrangement of a receiving device in an injection-molding machine;

FIG. 2 shows a schematic view of a mold of a receiving device;

FIG. 3 shows a further arrangement of a receiving device in an injection-molding machine;

FIG. 4 shows a mold with a stop for a positioning pin; and

FIG. 5 shows a mold with a recess for receiving a positioning pin.

### DETAILED DESCRIPTION OF THE INVENTION

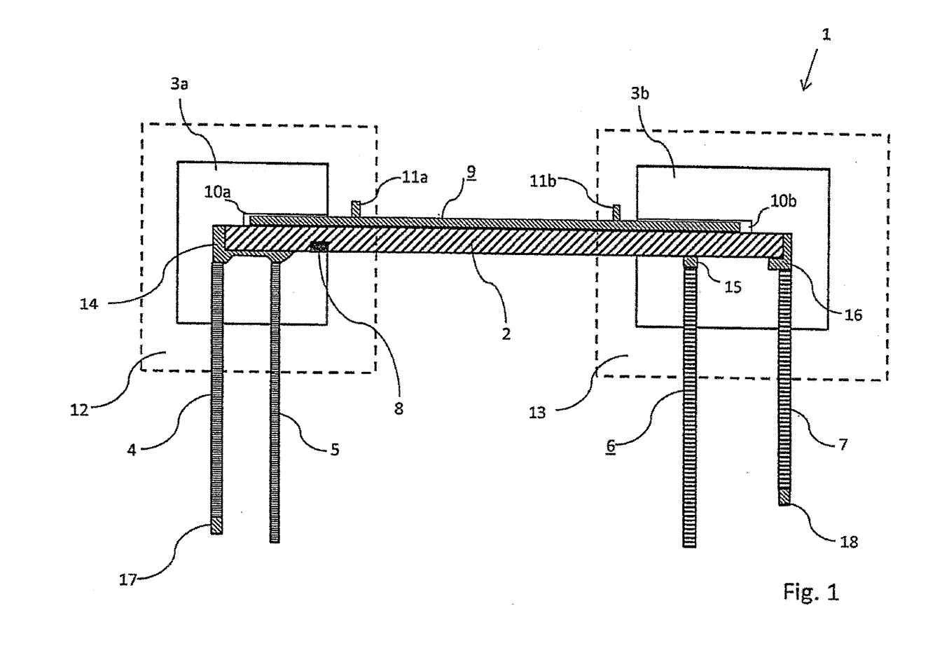

FIG. 1 shows a receiving device 1, a first central profile 2 being introduced therein. The receiving device 1 comprises two molds 3a and 3b, wherein the first profile at its left-hand end is mounted in the mold 3a and at its second end is mounted in the mold 3b. The profiles 4, 5, 6, and 7 are intended to be injection-molded onto the first profile 2, wherein to this end the profiles 4, 5 may be mounted in the mold 3a and injection-molded at the end, whilst the profiles 6, 7 may be connected to the first profile 2 via the mold 3b. During the injection-molding process, additionally a positioning pin 8 is injection-molded in the mold 3a. The positioning pin 8 is injection-molded with a different component from the profiles 4, 5, 6 and 7.

A connecting device 9 is arranged between the molds 3a and 3b. Each of the molds 3a, 3b has a receiving opening 10a, 10b, both the corresponding end of the first profile 2 and the corresponding part of the connecting device 9 being introduced therein. The first profile 2 is mounted in a dimensionally stable manner between the two molds, by the profile bearing against the connecting device 9. The connecting device 9 in turn is easily displaceable between the stops 11a and 11b, so that correspondingly a simple adaptation of the spacing between the two molds 3a and 3b may also be carried out and selected according to the length of the first profile 2 and according to the spacing of the two injection-molding machines 12, 13.

The two injection-molding machines 12, 13 are positioned fixedly relative to one another and have a defined spacing. Moreover, fixedly defined spacings are thus predetermined in the region of the first profile 2, a more accurate tolerance being able to be achieved overall by the distribution of the spacings. For example, proceeding from the left-hand stop in the region of the mold 3a, a positioning may take place relative to the positioning pin 8, for example. The profiles 6 and 7 may, in principle, be positioned relative to two reference points, namely firstly relative to the left-hand stop inside the mold 3a and secondly relative to the positioning pin 8. The profiles 4, 5, 6, 7 are injection-molded in the connecting region with the first profile in each case at the points 14, 15 and 16. These points 14, 15, 16 are injection-molded with one/a plurality of thermoplastic elastomer/s.

In the present case, it is also possible to injection-mold two different components in one of the molds 3a and/or 3b or even with one another in the respective molds. This injection-molding may take place simultaneously and this is also advantageously possible when the processing time is of variable length. The positioning pin 8 is injection-molded with a different plastics material, for example PP (polypropylene).

Moreover, in principle, plastics may also be injection-molded in the end region of profiles, whether in the end region of the first central profile or in the end region of a different adjacent profile. Such regions, which in the present case could also have been previously injection-molded, are located for example at the end regions of the profile 4 at the point 17, and in the end region of the profile 7 at the point 18. In the present case, the entire profile, which consists of the individual profiles 2, 4, 5, 6, 7, is a sealing profile for a vehicle door, wherein the part in the region of the mold 3a is used for the B-pillar and the region in combination with the mold 3b is used for the C-pillar.

The method according to the present invention, both the production method and also the positioning method, may in principle also take place without the connecting device 9. In the example according to FIG. 1, however, the tool is configured to carry out a dual injection-molding process on two injection-molding machines adjacent to one another.

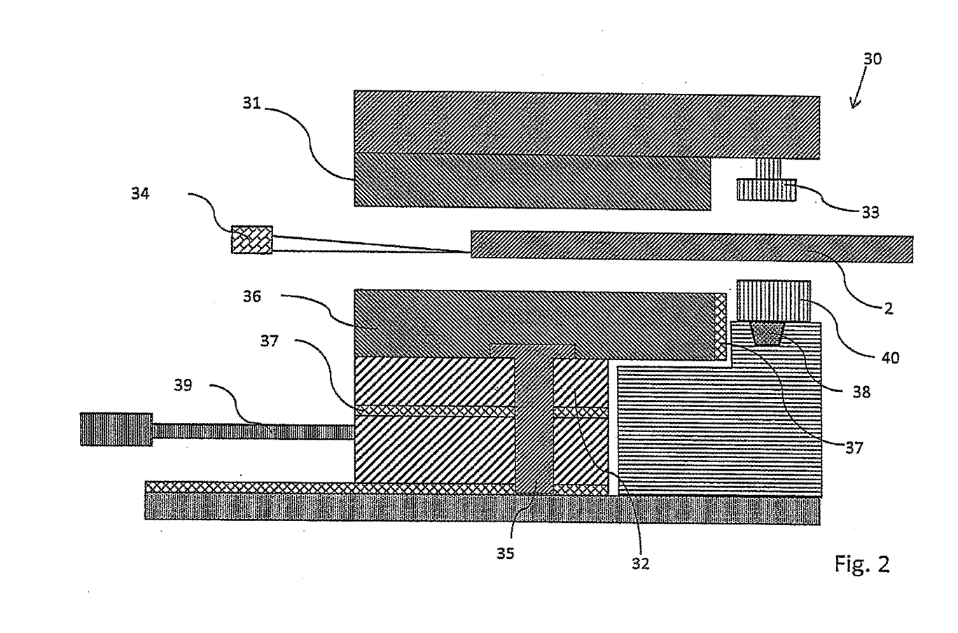

FIG. 2 shows a mold 30 with an upper part 31 and a lower part 32, wherein the upper part 31 comprises a pusher 33 for pushing the profile 2. The position of the profile 2 is determined and positioned via an optical distance sensor 34 operated by a laser. An ejector 35 is integrated in the lower part 32. The profile 2 is injection-molded with EPDM in the region of the mold part 36. The positioning pin in turn is injection-molded in the region of the mold part 38. Insulating regions 37 are provided for the insulation. The injection-molding with EPDM in the mold part 36 takes place at substantially higher temperatures than with PP in the region 38. An end region 56 may, for example, also be used as a stop for positioning. In principle, advantageously, cutting tolerances generally have no effect on the length dimensions. Whilst on one side an end (for example, the end 56) may serve as a stop for positioning, wherein in the present case according to FIG. 2 in any case an injection-molding takes place there, on the opposing side monitoring of the length may be undertaken by means of an optical distance sensor 34. Since the positioning pin 8 may be used as a profile receiver, once again a more accurate positioning of the profile is possible during production. The mechanical drive for the ejector 35 may be implemented by a cylinder 39 and/or mechanically. The flap valves 40 provide support against the injection-molding pressure.

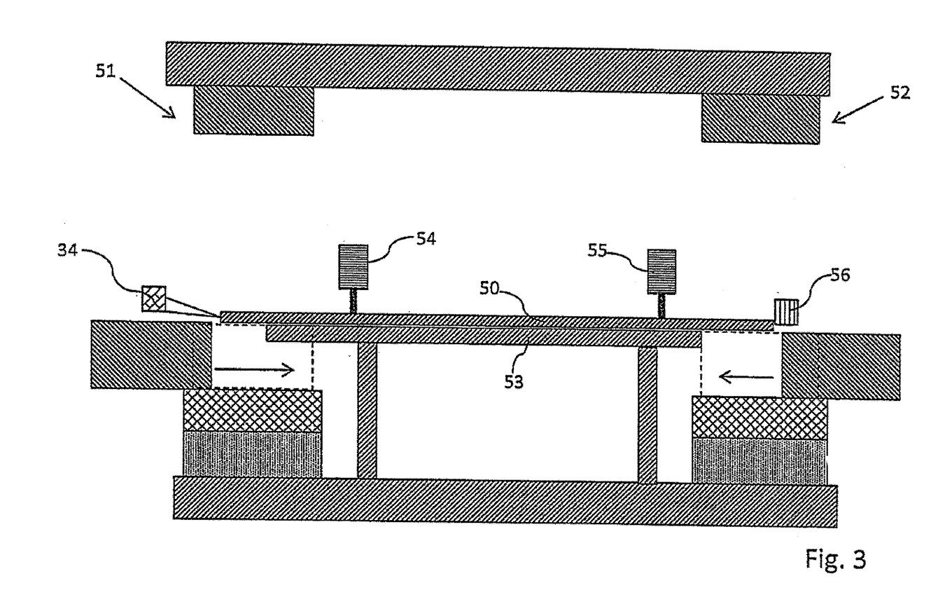

FIG. 3 shows a top profile 50 which is mounted between two molds 51, 52 and is held in a dimensionally stable manner via a connecting device 53. A profile is clamped in the regions 54, 55. In the right-hand region of the profile 50 (according to FIG. 3) an injection-molding 56 has been undertaken at the end thereof. This end 56 of the profile 50 serves as a stop in the mold 52 for further positioning. At the other end of the profile 50 a monitoring of the length/positioning is carried out via the optical sensor 34. The molds 51, 52 are respectively pushed onto the top profile 50 on both sides in each case. The accuracy of the positioning is, as a result, generally particularly good. The positioning may be carried out fully automatically. Advantageously, TPE, which requires a different process sequence, and EPDM may be injection-molded simultaneously (simultaneous injection-molding).

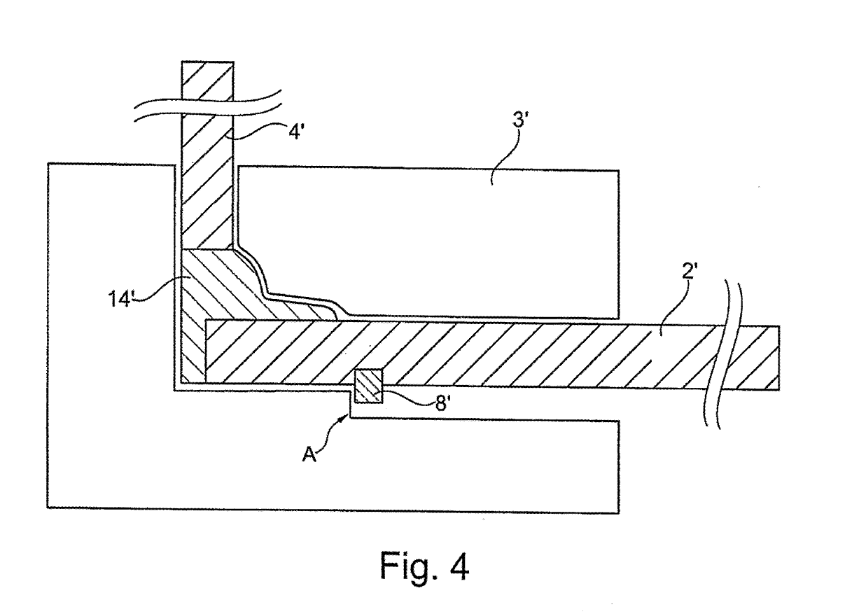

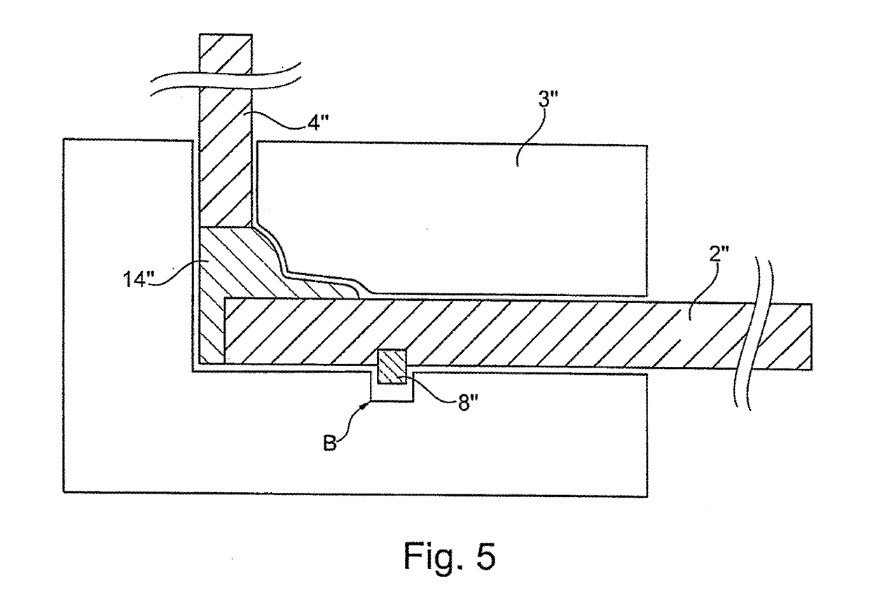

FIGS. 4 and 5 illustrate exemplary embodiments of positioning methods according to the present invention: both show schematic views of tool molds 3′ and/or 3″, in each case a first profile 2′ and/or 2″ and a further profile part 4′ and/or 4″ being clamped therein. The further profile parts 4′ and 4″ are injection-molded in the respective molds 3′ and 3″ onto the first profile 2′ and/or 2″ and namely in the regions (injection-moldings) 14′ and 14″. On the first profile 2′, 2″, in each case a positioning pin 8′, 8″ is injection-molded. If the mold 3′ in FIG. 4 is pushed onto the first profile 2′, the region A serves as a stop, so that when the profile 2′ bears with the positioning pin 8′ against the stop A, a defined position of the profile 2′ in the tool 3′ is present. In FIG. 5, the positioning pin 8″ may be alternatively inserted in the manner of a tab into the recess B in order to gain the desired positioning of the profile 2″ in the tool 3″.

### LIST OF REFERENCE NUMERALS

1 Receiving device
2 First/central profile
2′ First/central profile
2″ First/central profile
3a Mold
3b Mold
3′ Mold
3″ Mold
4 Additional profile
4′ Profile part to be injection-molded
4″ Profile part to be injection-molded
5 Additional profile
6 Additional profile
7 Additional profile
8 Positioning pin
8′ Positioning pin
8″ Positioning pin
9 Connecting device
10a Receiving opening
10b Receiving opening
11a Stop
11b Stop
12 Injection-molding machine
13 Injection-molding machine
14 Injection-moldings for profile connection
14′ Injection-moldings for profile connection
14″ Injection-moldings for profile connection
15 Injection-moldings for profile connection
16 Injection-moldings for profile connection
17 End injection-moldings
18 End injection-moldings
30 Mold
31 Upper part
32 Lower part
33 Pusher
34 Optical path sensor
35 Ejector
36 EPDM injection-molding/mold part
37 Insulation
38 Mold part (positioning pin)
39 Cylinder mechanism
40 Flap valves
50 Top profile
51 Mold
52 Mold
53 Connecting device
54 Profile clamp
55 Profile clamp
56 End stop
A Stop
B Recess

1. A method for producing a positionable sealing profile for vehicle doors, comprising a first profile being introduced and retained in a tool, the tool being a receiving device and/or a mold for receiving sealing profiles in a retained manner and for further processing thereof, such as for injection-molding further profiles and/or profile parts in an injection-molding machine and/or for cutting to length the sealing profiles, and subsequently at least two injection-molding processes are carried out before the tool is opened again and/or without the sealing profile alternatively being reclamped in a different tool, wherein during one of the at least two injection-molding processes a further profile part is injection-molded onto the first profile, and in a further of the at least two injection-molding processes a positioning pin is injection-molded at a side onto the first profile and/or onto the further profile part, the positioning pin being configured to be used as a stop for positioning on a vehicle and/or in a different tool.

2. The method as claimed in claim 1, wherein the positioning pin is injection-molded from a different material from the profile part.

3. The method as claimed in claim 1, wherein the profile part is injection-molded on one end of the first profile so that a sealing profile corner is formed.

4. A method for positioning a sealing profile for vehicle doors in a tool, the tool being a receiving device and/or a mold for receiving sealing profiles in a retained manner and for the further processing thereof, such as for injection-molding further profiles and/or profile parts in an injection-molding machine and/or for cutting to length the sealing profiles, by using a sealing profile with a positioning pin attached thereto, wherein the tool used comprises a stop and/or a recess, and the positioning pin is moved against the stop and/or introduced into the recess, such that the positioning pin and thereby the sealing profile retain a defined position in relation to the tool.

5. The method as claimed in claim 4, wherein a sealing profile with a positioning pin is used as the sealing profile, the positioning pin being injection-molded onto a profile part of the sealing profile.

6. The method as claimed in claim 4, wherein a sealing profile with a positioning pin is used as the sealing profile, the positioning pin being produced from a different material from the profile part onto which it is injection-molded.

7. The method as claimed in claim 2, wherein the positioning pin is injection-molded from a different plastics material from the profile part.

8. The method as claimed in claim 7, wherein the different plastics material is polypropylene.

9. The method as claimed in claim 6, wherein the positioning pin is produced from a different plastics material from the profile part.

10. The method as claimed in claim 9, wherein the different plastics material is polypropylene.
